(19) United States
(12) Patent Application Publication
(10) Pub. No.: US 2014/0278274 A1
(43) Pub. Date: Sep. 18, 2014

(54) AUTOMATIC OPTIMIZATION OF SCENE CONFIGURATION

(71) Applicants: Stanley J. Osher, Pacific Palisades, CA (US); Lap-Fai Yu, Boise, ID (US); Sai-Kit Yeung, Boise, ID (US); Demetri Terzopoulos, Los Angeles, CA (US); Tony F. Chan, Kowloon (HK); Chi-Keung Tang, Kowloon (HK)

(72) Inventors: Stanley J. Osher, Pacific Palisades, CA (US); Lap-Fai Yu, Boise, ID (US); Sai-Kit Yeung, Boise, ID (US); Demetri Terzopoulos, Los Angeles, CA (US); Tony F. Chan, Kowloon (HK); Chi-Keung Tang, Kowloon (HK)

(21) Appl. No.: 13/950,247

(22) Filed: Jul. 24, 2013

Related U.S. Application Data
(60) Provisional application No. 61/675,251, filed on Jul. 24, 2012.

(51) Int. Cl. G06F 17/50; G06N 99/00

(52) U.S. Cl. CPC G06F 17/50; G06N 99/005
USPC 703/1

(57) ABSTRACT

A method includes receiving one or more learning configurations, each learning configuration related to an acceptable arrangement of items within an environment. The method further includes extracting from the learning configurations representative item information and relationship information, synthesizing a configuration of items for a defined environment based at least in part on the extracted representative item information and relationship information, determining a cost of the synthesized configuration, and, based on the cost of the synthesized configuration, identifying the synthesized configuration as acceptable.

### CROSS-REFERENCE TO RELATED APPLICATION

This application claims the benefit of U.S. Provisional Patent Application 61/675,251 filed Jul. 24, 2012 to Yu et al., entitled “Automatic Optimization of Furniture Arrangement,” the contents of which are incorporated herein by reference in its entirety.

### STATEMENT REGARDING FEDERALLY SPONSORED RESEARCH OR DEVELOPMENT

This invention was made with Government support under Grant No. W911NF-09-1-0383, awarded by the U.S. Army Corps of Engineers, Army Research Office. The Government has certain rights in this invention.

### BACKGROUND

There are many applications in which it is desirable to create a product representing an arrangement of items in an environment. Examples of such products include digital representations and visual representations. Examples of arrangements include furniture arranged in a room, or plants, decking, and pavers arranged in a yard.

It is often further desirable to create a product representing arrangements of items in several environments, such as multiple views representing respective multiple room arrangements for a building, or multiple views representing respective multiple areas in an outdoor plaza. As the number of environments and/or the number of items to be arranged increases, the time correspondingly increases to prepare a product representing an arrangement of items in an environment.

It would thus be beneficial to have the capability of automatically creating products representing arrangements for various environments.

### SUMMARY

Embodiments of this disclosure include receiving one or more learning configurations, each configuration example related to acceptable arrangement of items within an environment. The method further includes extracting from the learning configurations representative item information and relationship information, synthesizing a configuration of items for a defined environment based at least in part on the extracted representative item information and relationship information, determining a cost of the synthesized configuration, and, based on the cost of the synthesized configuration, identifying the synthesized configuration as an acceptable configuration.

Embodiments of this disclosure further include receiving one or more learning configurations, each configuration example related to an acceptable arrangement of items within an environment, and extracting from the learning configurations representative item information and relationship information, wherein the representative item information includes an indication of at least one of a bounding surface, a center, an orientation, an accessible space, and a viewing frustum.

Embodiments of this disclosure further include receiving item information and relationship information, synthesizing a configuration of items for a defined environment based on the item information and relationship information, determining a cost of the synthesized configuration, and, based on the cost of the synthesized configuration, identifying the synthesized configuration as an acceptable configuration.

### BRIEF DESCRIPTION OF THE DRAWINGS

FIG. 1 illustrates an example representation of a system in which a scene-synthesizing system may be implemented.

FIG. 2 illustrates an example representation of a computing device.

FIG. 3 illustrates by way of a functional block diagram the components of an example scene-synthesizing system.

FIG. 4 illustrates examples of information extracted from learning configurations.

FIG. 5 illustrates examples of user input information.

FIG. 6A illustrates an example of user input item initialization information.

FIG. 6B illustrates an optimized layout generated by the scene-synthesizing system.

FIG. 6C illustrates another optimized layout generated by the scene-synthesizing system.

FIG. 7 illustrates an example of bounding surfaces of an item.

FIG. 8 illustrates an example of center and orientation of an item.

FIG. 9 illustrates an example of accessible spaces for an item.

FIG. 10 illustrates an example of a viewing frustum of an item.

FIG. 11A illustrates an example of an initialization configuration.

FIG. 11B illustrates an example of a synthesized scene configuration.

FIG. 11C illustrates another example of a synthesized scene configuration.

FIG. 12 illustrates an example of a pathway.

FIG. 13 illustrates an example of a pairwise relationship.

FIG. 14A illustrates an example of a synthesized scene configuration neglecting ergonomic considerations.

FIG. 14B illustrates an example of a synthesized scene configuration including ergonomic considerations.

FIGS. 15A-D illustrate learning configurations.

FIG. 16A-D illustrate synthesized scene configurations.

### DETAILED DESCRIPTION

Embodiments of this disclosure relate to a system that automatically synthesizes scenes realistically populated with a variety of items.

The scene-synthesizing system uses descriptive information about items to be placed and an environment to be populated to determine an acceptable (e.g., optimized) configuration for a given set of items within the environment. Descriptive information about items to be placed may be extracted by the scene-synthesizing system from examples of item placement. Alternatively or additionally, information about items to be placed may be provided as user input to the scene-synthesizing system. Information about an environment to be populated may be received as input to the scene-synthesizing system, or may be identified by the scene-synthesizing system by accessing other systems. The optimized placement of items within the environment may be provided as a visual scene at a graphical user interface on a display. Scenes may represent indoor spaces or outdoor spaces.

Embodiments of this disclosure may be incorporated into modeling software or game engines. For example, the scene-synthesizing system may be used to create scenes for movies or games, such as indoor scenes populated with furniture and decorative items, or outdoor scenes populated with green spaces and architectural objects. In the game Grand Theft Auto 4, for example, New York City is modeled as a gaming environment, and embodiments of this disclosure may be used to generate a furniture arrangement for one or more rooms in buildings of the city model such that a user may interactively navigate the rooms.

Embodiments of this disclosure may be incorporated into interior design software. For example, the scene-synthesizing system can be used to create furniture arrangement suggestions by inputting a room floor plan and selecting furniture and decorative items from a library, inputting information regarding items to be placed, or providing learning configurations and a list of items to be placed. The scene-synthesizing system may suggest multiple optimal furniture arrangements based on the floor plan and the items to be placed.

Embodiments of this disclosure may be incorporated into exterior design software. For example, the scene-synthesizing system could be used to create landscaping suggestions by inputting a yard outline and selecting plants and furniture from a library, inputting information regarding items to place, or providing learning configurations and a list of items to place. The scene-synthesizing system may suggest multiple optimal landscaping arrangements based on the yard outline and the items to be placed.

The modeling software, game engine, interior design software, and exterior design software are provided as illustrative but non-limiting examples of how the scene-synthesizing system of this disclosure may be used. Other uses will become apparent from the figures and following discussions.

Rules may be defined for the scene-synthesizing system, and the rules modified to allow for adaptability in different conditions. For example, in the context of the interior design software example, rules may be modified to address narrowing of walking spaces or occlusion of windows.

FIG. 1 illustrates an example of a system 100 in which the scene-synthesizing system may be implemented. System 100 includes multiple computing devices 110, and networks 120 and 125. Components of system 100 can realize various different computing model infrastructures, such as web services, distributed computing and grid computing infrastructures.

Computing device 110 may be one of many types of apparatus, device, or machine for processing data, including by way of example a programmable processor, a computer, a server, a system on a chip, or multiple ones or combinations of the foregoing. Computing device 110 may include special purpose logic circuitry, such as an FPGA (field programmable gate array) or an ASIC (application-specific integrated circuit). Computing device 110 may also include, in addition to hardware, code that creates an execution environment for a computer program, such as code that constitutes processor firmware, a protocol stack, a database management system, an operating system, a cross-platform runtime environment, a virtual machine, or a combination of one or more of the foregoing.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a network, such as network 120 or 125.

Networks 120 and 125 represent any type of network, such as a wide area network or a local area network, or a combination of networks. Networks 120 and 125 may include one or more of analog and digital networks, wide area and local area networks, wired and wireless networks, and broadband and narrowband networks. In some implementations, network 120 and/or network 125 may include a cable (e.g., coaxial metal cable), satellite, fiber optic, or other transmission media.

As illustrated in FIG. 1, computing device 110 may be in communication with another computing device 110 directly, or via one or more networks 120 and/or 125.

One computing device 110 of FIG. 1 is illustrated as being in communication with a display 130 having a graphical user interface (GUI) 140, and further illustrated as being in communication with a storage 150. Although one computing device 110 is illustrated as being in communication with display 130 (with GUI 140) and storage 150, other computing devices 110 may also be in communication with one or more displays 130 and one or more storages 150. Further, displays 130 and storages 150 may be shared by more than one computing device 110.

Display 130 is a viewing device such as monitor or screen attached to computing device 110 for providing a user interface to computing device 110. GUI 140 is a graphical form of user interface. Optimized scenes as determined by the scene-synthesizing system of this disclosure may be provided to GUI 140 for presentation to a user.

Storage 150 represents one or more memories external to computing device 110 for storing information, where information may be data or computer code.

The scene-synthesizing system of this disclosure may be implemented as computer-readable instructions in storage 150, executed by computing device 110.

FIG. 2 illustrates an example of computing device 110 that includes a processor 210, a memory 220, an input/output interface 230, and a communication interface 240. A bus 250 provides a communication path between two or more of the components of computing device 110. The components shown are provided by way of illustration and are not limiting. Computing device 110 may have additional or fewer components, or multiple ones of the same component.

Processor 210 represents one or more of a microprocessor, microcontroller, ASIC, and/or FPGA, along with associated logic.

Memory 220 represents one or both of volatile and non-volatile memory for storing information. Examples of memory include semiconductor memory devices such as EPROM, EEPROM and flash memory devices, magnetic disks such as internal hard disks or removable disks, magneto-optical disks, CD-ROM and DVD-ROM disks, and the like.

The scene-synthesizing system of this disclosure may be implemented as computer-readable instructions in memory 220 of computing device 110, executed by processor 210.

Input/output interface 230 represents electrical components and optional code that together provides an interface from the internal components of computing device 110 to external components. Examples include a driver integrated circuit with associated programming.

Communications interface 240 represents electrical components and optional code that together provides an interface from the internal components of computing device 110 to external networks, such as network 120 or network 125.

Bus 250 represents one or more interfaces between components within computing device 110. For example, bus 250 may include a dedicated connection between processor 210 and memory 220 as well as a shared connection between processor 210 and multiple other components of computing device 110.

FIG. 3 illustrates by way of a functional block diagram the components of an example scene-synthesizing system 300. An extraction component or module 310 extracts information from one or more learning configurations (e.g., as learning examples.) A synthesis component or module 320 receives one or both of the extracted information and user input, and generates a synthesized scene configuration as an acceptable output (e.g., and optimized output.) Learning configurations may be stored for later retrieval by extraction component 310. Extraction component 310 may store information extracted from the learning configurations for later retrieval by synthesis component 320. User input may be stored for later retrieval by synthesis component 320. Synthesis component 320 may store the optimized output for later display or other retrieval. For example, learning configurations, extracted information, user input, and/or optimized output may be stored in one or more of storage 150 or memory 220.

FIG. 4 illustrates examples of information extracted by extraction component 310. Extracted information includes extracted item information 410 and extracted relationship information 420. The depictions of item information 410 and relationship information 420 are by way of illustration, and do not necessarily signify any particular structural form for the corresponding information. Extracted information may be formatted, for example, in objects, linked lists, structs, databases, or other suitable structural form.

Extracted item information 410 includes information about representative items in the learning configurations. An item may be, for example, a piece of furniture, a lamp, a clock, artwork, a statue, a television, or a rug for an interior space; or a tree, a patch of grass, a plant, a barbecue grill, or furniture for an exterior space. Each representative item is described by a set of attributes, such as attributes of bounding surfaces, center, orientation, accessible space, and viewing frustum. Some items are further described in relation to other items. Extracted relationship information 420 includes information about representative relationships in the learning configurations. A relationship may be, for example, a spatial relationship, a hierarchical relationship, or a pairwise relationship. Item and relationship information is described in further detail below.

The items used in the learning configurations for attribute and relationship extraction may differ in appearance from those used in the synthesis.

FIG. 5 illustrates examples of information received by synthesis component 320. Synthesis component 320 may receive extracted information from extraction component 310, directly or from a memory, and may further receive user input, such as user input item information 510, user input relationship information 520, and user input analysis information 530. The depictions of item information 510, relationship information 520, and analysis information 530 are by way of illustration, and do not necessarily signify any particular structural form for the corresponding information.

User input item information 510 describes attributes of items that may be used by synthesis component 320. Similarly to extracted item information 410, each item input by the user is described by a set of attributes, such as bounding surfaces, center, orientation, accessible space, and viewing frustum. Some items are further described in relation to other items. Similarly to extracted relationship information 420, user input relationship information 520 includes information about relationships between items, such as a spatial relationship, a hierarchical relationship, or a pairwise relationship.

User input analysis information 530 is additional information provided by a user to customize the synthesis of synthesis component 320. Input analysis information 530 includes general constraints on the system, such as a width of walking areas or allowable light blockage, cost function weighting to shape the optimized output according to user preferences, and initialization parameters such as number and type of items and room dimensions and layout. Item, relationship, and analysis information is described in further detail below.

Items presented in an optimized output may be one of, or a combination of, items copied from the representative items in the learning configurations, items extrapolated from the representative items in the learning configurations, or items defined through user input.

The scene-synthesizing system automatically generates item configurations for complex scenes. The scenes are optimized in some manner. For example, scenes may be optimized with respect to ergonomic factors.

FIGS. 6A-6C graphically illustrate an example of scene synthesis for an indoor space. FIG. 6A shows an example of user input item initialization information provided to synthesis component 320 in the form of a set of items to be placed in a room. Each item includes attributes that are input by a user or extracted or extrapolated from learning configurations. Other initialization information, such as room dimensions and item relationships, are also available to synthesis component 320. Item relationships provide for a more realistic scene, considering that a subset of many possible spatial configurations of items are functional and livable. For example, the front of a television or computer screen should not be blocked, since it is supposed to be visible. Additionally, most of the items in a scene should be accessible to human habitants. A realistic space further includes hierarchical relationships, such as one item placed atop another, where the carrier item is denoted as the parent, and the supported item as its child. FIGS. 6B and 6C show two examples of designs automatically synthesized by synthesis component 320 using the initialization as shown in FIG. 6A, with factors such as visibility, accessibility, and hierarchy taken into consideration.

Optimizing a scene into a realistic and functional configuration can involve considerable complexity, taking into account multiple item attributes and various relationships, among other factors. The solution search space can be large. To address these issues, the initial layout can be adjusted iteratively by reducing or minimizing a cost function.

### Item Representation

As described above with respect to FIGS. 4 and 5, item information includes attributes such as bounding surfaces, center, orientation, accessible space, and viewing frustum, among other attributes.

Bounding Surfaces:

Each item may be represented by a set of bounding surfaces, which may be in the form of, for example, a rectangular bounding box, a convex hull, or other complex shapes. A “back” bounding surface is identified for every item. When determined from a configuration example, the back bounding surface is the one closest to a wall. Other surfaces are labeled as “non-back” bounding surfaces. The back bounding surface is used to define a reference plane for assigning other attributes. FIG. 7 illustrates an example of a television set, represented by a rectangular bounding box whose six bounding surfaces are labeled Surface 1 through Surface 6, where Surface 1 is the back bounding surface.

Center and Orientation:

FIG. 8 illustrates the attributes of center and orientation of an item with respect to its bounding surfaces. Center is denoted by pᵢ, representing the (x, y) coordinates of the item. Orientation is denoted by ‘Θᵢ’, the angle between the nearest wall and the back bounding surface of the item. Center and orientation are denoted together as (pᵢ, Θᵢ). An optimized configuration {(pᵢ, Θᵢ)} involving all items ‘i’ is one that reduces or minimizes a cost function. Cost function is described in further detail below.

Accessible Space:

For each bounding surface of an item, a corresponding accessible space is defined. FIG. 9 illustrates an example of accessible space for the bounding surfaces of a chair. The center coordinates of an accessible space ‘k’ of item ‘i’ are denoted ‘aᵢₖ’. The diagonal of an accessible space ‘k’ of item ‘i’ is denoted by ‘adᵢₖ’, which is used to specify how deep other items may penetrate into the accessible space ‘k’ during optimization. The size of the accessible space is extracted from learning configurations, or provided as input related to the size of a human body. For example, if a bounding surface is very close to the wall in all of the learning configurations, the corresponding accessible space will be small. If the size of the accessible space is not extracted or provided as input, it defaults to a value, such as a width of an average-sized adult.

Viewing Frustum:

For some items, such as a television set or painting, the frontal surface of the item should appear to be visible in a synthesized configuration. A viewing frustum is assigned to the frontal surface of such items. Given an item ‘i’, its viewing frustum is approximated by a series of rectangles with center coordinates ‘vᵢₖ’, where ‘k’ is the rectangle index. The diagonal of a rectangle, ‘vdᵢₖ’, may be used to specify how close other items may approach during optimization, to limit encroachment into a viewing space. FIG. 10 illustrates an example of a viewing frustum.

Other Attributes:

Other attributes may also be used in the optimization process. An attribute may be the z-coordinate position of the item. To simplify the optimization process, the optimization may consider only the (x, y) coordinate space, such that an item's z-coordinate position is fixed as the z-coordinate position of the surface of its first-tier parent. Even using this simplification, the z-coordinate position may still be allowed to change in the swapping step described below, when a second-tier item changes its first-tier parent and is placed on a different surface. Additionally, possible collisions in the z-dimension may be considered when evaluating accessibility and visibility costs. For example, an overlap between a chair and a bed in the (x, y) coordinate space may be penalized as it involves a collision in the z-coordinate dimension, while overlap between a wall clock and a bed may not be penalized because it involves no collision in the z-coordinate dimension.

### Relationship Representation

Spatial Relationships:

Spatial relationships include the distance ‘dᵢ’ of the center of an item to its nearest wall, diagonal ‘bᵢ’ from the item center to an intersection of the item's bounding surfaces, and the item's relative orientation to the wall, ‘Θᵢ’. When spatial relationships are extracted from learning configurations, the spatial relationships may be estimated as the clustered means or averages of the respective relationships in the learning configurations.

Hierarchical Relationships:

Given two items A and B, item A is defined as the parent of B (and B as the child of A) if A is supporting B by a certain surface. For example, a candelabrum on top of a table is a child of the table, and the table is the parent of the candelabrum. In an example room, the room is regarded as the root, and all items directly supported by the floor or the wall of the room (e.g. bed, table, clock on the wall) are defined as “first-tier items.” Items supported by a surface of a first-tier item are defined as “second-tier items.” A room configuration is thus represented by a hierarchy of relationships. The scene-synthesis system may use hierarchical relationships with three or more tiers for more vertically-oriented scenes.

Pairwise Relationships:

Certain items, such as a television set and a sofa, or a dining table and chairs, interact with each other in pairs subject to pairwise orientation and distance constraints. Each pairwise relationship may be set in the attributes of the corresponding items, or set as a separate relational attribute. Pairwise relationships such as mean relative distance and angle may be extracted from learning configurations for use as pairwise constraints.

### Scene Configuration Synthesis

Item information and relationship information is integrated into an optimization framework with a defined cost function quantifying the quality of each configuration output of the scene-synthesizing system. For example, given an arbitrary room layout and a set of items, a synthesized scene configuration should be useful for virtual environment modeling in games and movies, interior design software, or other applications, according to constraints such as ergonomic constraints.

The search space of the synthesis can be complex, as items are interdependent during the optimization process. Thus, a global optimization scheme or a closed-form solution that yields a unique optimum may not be practical in some embodiments. For a given environment and set of items, numerous acceptably-good configurations may be possible. Therefore, the scene-synthesizing system approximates the global optimum.

One such approximation is achieved using a stochastic optimization technique. An example of a stochastic optimization technique is simulated annealing with a Metropolis-Hastings state-search step. Simulated annealing is a computational representation of the physical annealing process, which gradually lowers the temperature of a heat bath that controls the thermal dynamics of a solid in order to bring it into a low-energy equilibrium state. Theoretically, the technique can reach the global minimum at a logarithmic rate given a sufficiently slow cooling schedule. Although a slow cooling schedule may be impractical, simulated annealing can be used to find quasi-optimal configurations in circuit design, operations, and many other scientific problems.

By analogy, the items to be placed in a synthesis are regarded as the atoms of a metal being annealed—the metal is initially “heated up” (i.e., items are randomly placed), and the configuration of items is refined as the “temperature” gradually decreases to zero. For each reconfiguration of the items (at a “temperature” transition), the Metropolis criterion is used to determine the transition probability.

The simulated annealing employs a Boltzmann-like objective function

ƒ(φ)=e^{-βC(φ)} (1)
m)
   where the state of the system φ={(pᵢ, θᵢ)|i=1, . . . , n} represents a configuration of the positions ‘pᵢ’ and orientations ‘Θᵢ’ of each of ‘n’ items, C is a cost function (analogous to the energy function), and ‘β’ increases at every iteration (analogous to the inverse of temperature, increasing over the iterations as the system anneals from a high temperature to a low temperature.) At each iteration, a new configuration φ′ (also referred to as a “move”) is proposed, and it is accepted with probability

$$\begin{matrix}a ( {Φ}^{′} \vert Φ ) = min [ \frac{f ( {Φ}^{′} )}{f ( Φ )} , 1 ] & ( 2 ) \\ = min [ exp ( β ( C ( Φ ) - C ( Φ ) ) & ( 3 )\end{matrix}$$

The Metropolis criterion can accept moves that increase the cost, which allows the technique to avoid becoming stuck at local minima.

FIGS. 11A-11C illustrate an example synthesis with respect to furniture. The furniture items are initialized in random positions and orientations as illustrated in FIG. 11A, a configuration that typically has a high cost. As ‘β’ is increased and the furniture items are moved, successive iterations tend to have lower cost. When an optimal minimal cost is obtained, the configuration may be identified as an optimized scene configuration. FIG. 11B illustrates the example initialized as in FIG. 11A after 5,000 iterations, and FIG. 11C illustrates the same example after 25,000 iterations.

To explore the space of possible configurations effectively, a proposed move φ→φ′ may include one or both of a local adjustment which modifies the present configuration, and a global reconfiguration step that swaps items, thereby altering the configuration significantly.

Translation and Rotation:

A basic move modifies the position of an item and its orientation. For the purposes of the furniture arrangement problem, two-dimensional translation and rotation transformations suffice to configure items into practicable configurations, since in most cases furniture items stand upright on the floor due to gravity. Performing translation and rotation separately may provide a more stable optimization. In mathematical terms, an item ‘i’ or a subset of items is selected and updated with one of the moves

(pᵢ,Θᵢ)→(pᵢ+δpᵢ,Θᵢ) OR (pᵢ,Θᵢ)→(pᵢ,Θᵢ+δΘ) OR (pᵢ,Θᵢ)→(pᵢ+δp,Θᵢ+δΘ) (4)

where

δp≈[N(0,σₚ²)]^{2T} (5)

δΘ≈N(0,σₑ²) (6)

with

N(μ,σ²)=(2πσ²)^{-1/2}e^{-(x-μ)}^{²}^{/2σ}^{²} (7)

being a normal (Gaussian) distribution of mean ‘μ’ and variance ‘σ²’. The variances

σₚ², σₑ²

which determine the average magnitude of the moves, are inversely proportional to ‘β’.

Swapping Items:

To allow a more rapid exploration of the configuration space and avoid becoming stuck in local minima, a move involving swapping items in the existing configuration may be proposed. Two items of the same tier may be selected at random and their positions and orientations interchanged. Item swapping may lead to considerable rearrangement and significant cost increases/decreases within one iteration.

Moving Pathway Control Points:

Given two ingress/egress locations, multiple pathways are possible. By moving the control points of the pathway, which is represented as a cubic Bezier curve, the pathway can change its course to avoid colliding with scene items. The free space of a pathway is represented by a series of rectangles along the curve. Thus, pathways may also be regarded as items whose control points may be modified, and a move may be defined as the translation of a pathway control point in a certain direction.

Given a floor plan and a fixed number of items that define the solution space, the configuration of an item (pᵢ, Θᵢ) has a positive probability to move to any other configuration (pᵢ′, Θᵢ′). The annealing schedule allows the solution space to be explored more extensively with larger moves early in the optimization, and allows the configuration to be more finely tuned with smaller moves towards the end.

### Cost Function

A goal of the optimization process is to reduce or minimize a cost function that characterizes realistic, functional item configurations. To quantify the “realism” or “functionality” of a configuration, the following basic criteria are included in the cost function.

Accessibility:

As described above, an accessible space is defined for every face of an item. To favor accessibility, the cost increases whenever any item moves into the accessible space of another item. For example, if item ‘i’ overlaps with the accessible space ‘k’ of item ‘j’, the accessibility cost is defined as

$${C}_{a} ( Φ ) = {\sum }_{i} {\sum }_{j} {\sum }_{k} max [ 0 , 1 - \frac{‖ {p}_{i} - {a}_{jk} ‖}{{b}_{i} + {ad}_{jk}} ] \qquad ( 8 )$$

The move as shown in equation (8) is simplified by dropping the optimization of orientation ‘Θᵢ’. Experiments show that this simplification suffices to ensure accessibility and more easily prompts an overlapping item to move away.

Visibility:

Some items have requirements on the visibility of one or more surfaces. For surfaces that should be visible, a viewing frustum is associated with the item. When an item moves into another item's viewing frustum, the cost increases in order to discourage the move. As discussed above, for an item ‘j’ the viewing frustum is approximated by a series of rectangles whose center coordinates are defined as ‘vⱼₖ’. If item ‘i’ overlaps with a visibility rectangle ‘k’ of item ‘j’, the visibility cost is defined as

$${C}_{v} ( Φ ) = {\sum }_{i} {\sum }_{j} {\sum }_{k} max [ 0 , 1 - \frac{‖ {p}_{i} - {v}_{jk} ‖}{{b}_{i} + {vd}_{jk}} ] \qquad ( 9 )$$

Pathway:

The placement of items such that ingresses/egresses are blocked is inhibited by default, although the default may be adjusted, for example, for an unused ingress/egress. Additionally, configurations with circuitous and narrow pathways are avoided by default, although the default may be adjusted if desired. Default path width and/or curvature may be adjusted to provide, for example, for handicap accessibility. The locus of a pathway is by default defined by a cubic Bezier curve, where the free space of the pathway is approximated by a series of rectangular items, as illustrated in FIG. 12. Movement of items into the rectangles of the pathway curve is penalized. The pathway may be adjusted by translating the control points of the Bezier curve. Because a pathway should be free of obstacles and thus visible, the pathway cost Cₚₐₜₕ(φ) can be defined similarly to Cᵥ(φ) (defined in equation (9)), and the cost applied to the series of rectangles along the pathway.

Priors:

The prior cost controls the similarity between a new configuration and previous configurations, such as configurations in the learning configurations, or configurations assigned by a user. Given a new environment, the current configuration will be compared with a prior configuration as shown in equations (10) and (11).

$$\begin{matrix}{C}_{pr}^{d} ( Φ ) = {\sum }_{i} ‖ {d}_{i} - {\overline{d}}_{i} ‖ & ( 10 ) \\ {C}_{pr}^{θ} ( Φ ) = {\sum }_{i} ‖ {θ}_{i} - {\overline{θ}}_{i} ‖ & ( 11 )\end{matrix}$$

where ‘dᵢ’ and ‘Θᵢ’ can be computed from the current ‘pᵢ’, finding the distance and relative angle to the nearest wall.

Pairwise Constraint:

The pairwise constraint is applied between two items with a specific pairwise relationship. For example, in a furniture arrangement, a television set will be facing the sofa as illustrated in FIG. 13, and a bedside table will be close to a bed. Pairwise constraints Cₚₐᵢᵣ^{d}(φ) and Cₚₐᵢᵣ^{θ}(φ) are defined by replacing distance and orientation to the wall with the desired distance and orientation between the pair of items.

The overall cost function is defined as

C(φ)=ωₐCₐ(φ)+ωᵥCᵥ(φ)+ωₚₐₜₕCₚₐₜₕ(φ)+ωₚᵣ^{d}Cₚᵣ^{d}(φ)+ωₚᵣ^{θ}Cₚᵣ^{θ}(φ)+ωₚₐᵢᵣ^{d}Cₚₐᵢᵣ^{d}(φ)+ωₚₐᵢᵣ^{θ}Cₚₐᵢᵣ^{θ}(φ) (12)

The ‘ω’ coefficients determine the relative weighting between the cost terms. For example, one set of ‘ω’ coefficients used in a trial was ωₐ=0.1, ωᵥ=0.01, ωₚₐₜₕ=0.1, ωₚᵣ^{d}=ωₚₐᵢᵣ^{d}=[1.0,5.0], and ωₚᵣ^{θ}=ωₚₐᵢᵣ^{θ}=10.0.

FIGS. 14A and 14B illustrate by way of example the effect of omitting individual terms (i.e., setting an ‘ω’ coefficient to zero.) FIG. 14A illustrates an unsatisfactory spatial arrangement resulting from the neglect of human ergonomics considerations, where the result in this example has items packed together and blocking a door. FIG. 14B illustrates a satisfactory arrangement considering ergonomic factors, with realistically positioned items appropriately accessible without blocking the door.

Second-tier items attach to their first-tier parents if they are not already attached when the optimization begins. Optimization may be readily extended to second-tier items, such as to move second-tier items on the supporting surfaces provided by their first-tier counterparts in the same way that items move over a bottom (i.e., floor) space.

### Examples of Learning and Synthesis

In a demonstration of the scene-synthesizing system, seven scenes were selected: Living Room, Bedroom, Factory, Flower Shop, Gallery, Resort, and Restaurant. For each scene, five learning configurations were provided to the system. FIGS. 15A-D illustrate four of the learning configurations, for Flower Shop, Factory, Gallery, and Restaurant, respectively.

For each scene, five different furniture configurations were synthesized. The respective positions and orientations of the windows, doors, and ceiling fans were fixed and not updated during the optimization.

Table 1 tabulates the computational complexity, running time, number of iterations, and pairwise relationships of each scene.

TABLE 1

| | Number of | Pairwise | Number of | Total Time |
|---|---|---|---|---|
| | Objects | Relationships | Iterations | (sec) |
| Living Room | 20 | television & sofa | 20000 | 22 |
| Bedroom | 24 | television & | 20000 | 48 |
| | | armchair, desk & | | |
| | | work chair | | |
| Restaurant | 54 | chair & dish set, | 25000 | 219 |
| | | chair & table | | |
| Resort | 30 | easel & stool, | 42000 | 126 |
| | | drum & chair, | | |
| | | guitar & chair, | | |
| | | couch & tea table | | |
| Factory | 51 | work desk & chair, | 42000 | 262 |
| | | supervisor's | | |
| | | desk & chair | | |
| Flower Shop | 64 | none | 22000 | 376 |
| Gallery | 35 | chair & chair | 18000 | 88 |

FIGS. 16A-D illustrate an example of a synthesis output for the four scenes of FIGS. 15A-D, respectively. The synthesized Flower Shop scene provides an example of the effect of the pathways constraint, which maintains a clear path between the doors despite the dense coverage of the remainder of the room by flowers. The accessibility constraint also prevents the cashier from being blocked. The synthesized Factory scene shows the efficacy of the pairwise constraint. By modifying the weights of the pairwise distance and orientation terms, different groupings of work desks and chairs may be obtained. The accessibility and visibility constraints acting together prevent the door and poster from being blocked. The Gallery was based on an image of the Yale University Art Gallery, and is a non-rectangular room supported by numerous pillars. The synthesized Gallery scene suggests a new interior configuration for the gallery, where optimizing visibility and accessibility helps avoid obstruction of the pictures and information counter. The Restaurant example illustrates the significance of the pairwise relationship on both first-tier and second-tier items. With the use of a concentric spatial relationship between the chairs and table extracted from the learning configurations, different numbers of chairs are correctly oriented and evenly distributed around their respective tables, and each table setting is near and properly oriented to its corresponding chair.

### Perceptual Study

A perceptual study was performed to evaluate the realism and functionality of synthesized scene configurations. A null hypothesis H0 was that people would perceive no significant differences in the functionality of the synthesized scene configurations relative to those produced by a human designer given the same environment and sets of items. The alternative hypothesis H1 was that people would perceive significant differences. The experiment was conducted using a subjective, two-alternative, forced-choice preference approach. 25 volunteer participants were recruited who were unaware of the purpose of the perceptual study. The participants included 18 males and 7 females whose ages ranged from 20 to 60. All participants reported normal or corrected-to-normal vision with no color-blindness, and reported that they were familiar with the indoor scenes to be tested in the study. 14 participants reported that they did not have any expertise in interior design.

The synthesized scene configurations were compared against human-designed arrangements. To assess the significance of priors and pairwise constraints, two additional synthesized scene configurations were produced by respectively setting ωₚᵣ^{d}=ωₚₐᵢᵣ^{d}0 and ωₚᵣ^{θ}=ωₚₐᵢᵣ^{θ}=0. Removing the distance constraint resulted, for example, in the couch in the Living Room scene not placed against the wall, and work-chairs in the Factory scene placed far from their respective work desks. Removing the orientation constraint resulted, for example, in the television set in the Living Room scene oriented at an awkward angle against a wall, and work chairs in the Factory scene oriented arbitrarily.

The study involved static two-dimensional image viewing to eliminate differences due to varying degrees of skill in using navigation software among the participants. The viewing of video was avoided because, as preliminary experiments showed, repeated video viewing easily causes fatigue.

A comparison included a pair of color panels (also referred to as plates) for a scene, each panel with three views. The views on one panel were synthesized, and the views on the other panel created by a human designer. Each participant viewed 70 panel pairs (7 scenes×5 panel pairs per scene×2 trials). Participants were provided with the following task description:
This test is about selecting a color plate from a pair of color plates, and there are 70 pairs in total. Each plate shows three views of a furniture arrangement. You will be shown the plates side-by-side with a grey image displayed between each evaluation.
Your task in each evaluation is to select the arrangement in which you would prefer to live, stay, work, visit, etc., depending on the primary function of the room, by clicking on the color plate. You can view the test pair for an unlimited amount of time, but we suggest that you spend around 15 seconds on each set before making your selection.

The color panels were presented to each participant in a different random order. Counterbalancing was used to avoid any order bias. Each panel pair was assessed twice by each participant: in half of the trials the synthesized configurations were displayed as the left panel, and in the other half of the trials the synthesized configurations were displayed as the right panel.

The collected preference outcomes were analyzed to determine if any statistically significant trend existed. A Chi-square nonparametric analysis technique was used. The Chi-square values were computed (degrees of freedom=1) and then tested for significance (level of significance=0.5). Table 2 tabulates the survey results, where A_{E} represents the human-designed arrangement, A₁, A₂, A₃ represent configurations synthesized considering distance and orientation, and A₄, A₅ are, respectively, configurations synthesized without considering distance and orientation. Values shown in bold indicate significant differences.

TABLE 2

| | A_{E}/A₁ | | A_{E}/A₂ | | A_{E}/A₃ | | A_{E}/A₄ | | A_{E}/A₅ | |
|---|---|---|---|---|---|---|---|---|---|---|
| Scene | x²-value | p-value | x²-value | p-value | x²-value | p-value | x²-value | p-value | x²-value | p-value |
| Living Room | 1.210 | 0.271 | 0.010 | 0.920 | 0.010 | 0.920 | 5.290 | 0.021 | 10.89 | 0.001 |
| Bedroom | 0.810 | 0.368 | 7.290 | 0.007 | 0.010 | 0.920 | 4.410 | 0.036 | 20.09 | 0.000 |
| Factory | 0.490 | 0.484 | 1.690 | 0.194 | 0.810 | 0.368 | 13.69 | 0.000 | 20.25 | 0.000 |
| Flower Shop | 0.090 | 0.764 | 9.610 | 0.002 | 6.250 | 0.012 | 0.090 | 0.764 | 10.89 | 0.001 |
| Gallery | 0.250 | 0.617 | 3.610 | 0.057 | 0.090 | 0.764 | 1.690 | 0.194 | 3.610 | 0.057 |
| Resort | 0.010 | 0.920 | 2.890 | 0.089 | 0.090 | 0.764 | 9.610 | 0.002 | 12.25 | 0.000 |
| Restaurant | 3.610 | 0.057 | 0.250 | 0.617 | 1.690 | 0.194 | 8.410 | 0.004 | 2.890 | 0.089 |

The results indicate that the arrangements created by humans are not clearly preferred over the configurations A₁, A₂, and A₃, in which all of the cost terms were included in the optimization. For example, for the A_{E}/A₁, A_{E}/A₂, A_{E}/A₃ pairs, among the 21 synthesized configurations, 3 showed a significant difference (p<0.05) inasmuch as most of the participants were able to identify the human-designed arrangement in these cases.

A Bayesian analysis was used to determine whether the number of participants who selected the synthesized layout was what would be expected by chance, or if there was a preference pattern. For each scene, it was assumed that the participant had a probability P of picking the human-designed arrangement, and that the results of different trials of the same scene were independent of each other. Based on these assumptions, a binomial distribution was used to model the results, where the only parameter was P. For this case, H₀ has P=0.5 and H₁ has P=[0, 1]. The odds ‘O’ were computed on H₀ over H₁, where O>3 is considered to indicate a favoring of H₀ whereas O<⅓ indicates a favoring of H₁, while other odds values ‘O’ are inconclusive. Table 3 tabulates the computed odds.

TABLE 3

| | A_{E}/A₁ | A_{E}/A₂ | A_{E}/A₃ | A_{E}/A₄ | A_{E}/A₅ |
|---|---|---|---|---|---|
| Scene | odds | odds | odds | odds | odds |
| Living Room | (1.377) | 5.506 | 5.506 | 0.016 | 0.000 |
| Bedroom | (2.135) | 0.002 | 5.506 | 0.042 | 0.000 |
| Factory | 3.050 | (0.818) | (2.135) | 0.000 | 0.000 |
| Flower Shop | 4.894 | 0.000 | 0.005 | 4.894 | 0.000 |
| Gallery | 4.020 | 0.102 | 4.894 | (0.818) | 0.102 |
| Resort | 5.506 | 0.223 | 4.894 | 0.000 | 0.000 |
| Restaurant | 0.102 | 4.020 | (0.818) | 0.000 | 0.223 |

For the A_{E}/A₁, A_{E}/A₂, A_{E}/A₃ pairs, among the 21 synthesis results, 10 favor H₀, indicating the lack of a significant perceived difference between the synthesized and the human-designed arrangements, 6 favor H₁, indicating a significant difference, and 5 are inconclusive.

With respect to orientation and distance, most participants chose the human-designed arrangement when the distance or orientation constraint was inhibited, and it was easier for participants to detect the synthesized configuration when the orientation term was inhibited than when the distance term was inhibited. These results suggest that a greater weight may be applied in penalizing orientation deviation during optimization.

The system has further been demonstrated to be effective in a “tight fit” scenario, where many functional groupings of items (e.g., work desks and chairs) are possible, as well as in a “loose fit” scenario, where the placement is more flexible and items to be placed are more diverse. The system is flexible to accommodate specific constraints related to human factors, which may be readily encoded into the accessibility and pathway terms in order to generate livable configurations.

Other considerations that may be incorporated into the learning and/or syntheses processes include lighting and acoustics of an environment, and subjective, aesthetic issues such as styles or colors to add balance, harmony, or emphasis.

Thus is described a system for the automatic synthesis of scene configuration, avoiding manual or semi-automated approaches that are impractical in many graphics applications. The system considers human factors such as accessibility, visibility, and pathway constraints. The effectiveness of the automated approach in synthesizing various scene configurations has been shown, and the results deemed by human observers to be perceptually valid compared to arrangements generated by human de-signers.

An embodiment of the disclosure relates to a non-transitory computer-readable storage medium having computer code thereon for performing various computer-implemented operations. The term “computer-readable storage medium” is used herein to include any medium that is capable of storing or encoding a sequence of instructions or computer codes for performing the operations, methodologies, and techniques described herein. The media and computer code may be those specially designed and constructed for the purposes of the invention, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (“ASICs”), programmable logic devices (“PLDs”), and ROM and RAM devices. Examples of computer code include machine code, such as produced by a compiler, and files containing higher-level code that are executed by a computer using an interpreter or a compiler. For example, an embodiment of the disclosure may be implemented using Java, C++, or other object-oriented programming language and development tools. Additional examples of computer code include encrypted code and compressed code. Moreover, an embodiment of the disclosure may be downloaded as a computer program product, which may be transferred from a remote computer (e.g., a server computer) to a requesting computer (e.g., a client computer or a different server computer) via a transmission channel. Another embodiment of the disclosure may be implemented in hardwired circuitry in place of, or in combination with, machine-executable software instructions.

While certain conditions and criteria are specified herein, it should be understood that these conditions and criteria apply to some embodiments of the disclosure, and that these conditions and criteria can be relaxed or otherwise modified for other embodiments of the disclosure.

While the invention has been described with reference to the specific embodiments thereof, it should be understood by those skilled in the art that various changes may be made and equivalents may be substituted without departing from the true spirit and scope of the invention as defined by the appended claim(s). In addition, many modifications may be made to adapt a particular situation, material, composition of matter, method, operation or operations, to the objective, spirit and scope of the invention. All such modifications are intended to be within the scope of the claim(s) appended hereto. In particular, while certain methods may have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

1. A non-transitory computer-readable medium, comprising executable instructions to:
receive at least one learning configuration related to an acceptable arrangement of items within a learning environment;
extract from the learning configuration information including representative item information and representative relationship information for the items; and
synthesize a configuration of the items for a defined environment based on the extracted information.

2. The medium of claim 1, wherein the representative item information includes an indication of at least one of a bounding surface, a center, an orientation, an accessible space, and a viewing frustum of an item, and the representative relationship information includes an indication of at least one of a spatial relationship, a hierarchical relationship, and a pairwise relationship between items.

3. The medium of claim 1, further comprising executable instructions to receive user-specified information including item information and relationship information via a user interface, and the executable instructions to synthesize include executable instructions to synthesize the configuration based on the user-specified information.

4. The medium of claim 1, wherein the defined environment corresponds to an indoor or outdoor scene, and the items correspond to objects to be placed in the indoor or outdoor scene.

5. The medium of claim 1, wherein the executable instructions to synthesize include executable instructions to:
define a cost function for an arrangement of the items within the defined environment;
translate at least one item in an X-Y plane of the defined environment; and
based on the cost function, calculate a cost of a configuration resulting from the translating.

6. The medium of claim 1, wherein the executable instructions to synthesize include executable instructions to:
define a cost function for an arrangement of the items within the defined environment;
rotate at least one item in an X-Y plane of the defined environment; and
based on the cost function, calculate a cost of a configuration resulting from the rotating.

7. The medium of claim 1, wherein the executable instructions to synthesize include executable instructions to:
define a cost function for an arrangement of the items within the defined environment;
translate the control point of at least one pathway in an X-Y plane of the defined environment; and
based on the cost function, calculate a cost of a configuration resulting from the translating of the control point of the pathway.

8. The medium of claim 1, wherein the executable instructions to synthesize include executable instructions to:
define a cost function for an arrangement of the items within the defined environment;
swap items in an X-Y plane of the defined environment; and
based on the cost function, calculate a cost of a configuration resulting from the swapping.

9. The medium of claim 1, wherein the executable instructions to synthesize include executable instructions to:
define a cost function for an arrangement of the items within the defined environment;
translate at least one item in a Z direction of the defined environment; and
based on the cost function, calculate a cost of a configuration resulting from the translating.

10. The medium of claim 1, wherein the executable instructions to synthesize are subject to at least one of a constraint on a pathway width, a constraint on a pathway curvature, a constraint on an acoustic parameter, and a constraint on a color parameter.

11. The medium of claim 1, wherein the learning environment is different from the defined environment.

12. A method, comprising:
providing item information and relationship information for items to be placed in a scene;
based on the item information and relationship information, defining a cost function for a synthesized configuration of the items within the scene;
based on the cost function, determining a cost of the synthesized configuration; and,
based on the cost of the synthesized configuration, identifying the synthesized configuration as an acceptable configuration.

13. The method of claim 12, wherein the item information includes an indication of at least one of a bounding surface, a center, an orientation, an accessible space, and a viewing frustum.

14. The method of claim 12, wherein the relationship information includes an indication of at least one of spatial relationship, a hierarchical relationship, and a pairwise relationship.

15. The method of claim 12, wherein determining the cost includes calculating at least one cost parameter selected from:
a cost of a position in an X-Y configuration space;
a cost of a position in an X-Y-Z configuration space;
a cost of a position of a first item with respect to an accessible space of another item;
a cost of a position of a second item with respect to a viewing frustum of another item;
a cost of violating a constraint of a spatial relationship; and
a cost of violating a constraint of a pairwise relationship.

16. The method of claim 15, wherein determining the cost includes assigning weighting values to the at least one cost parameter.

17. The method of claim 12, wherein the acceptable configuration is one of a plurality of acceptable configurations.

18. The method of claim 12, wherein providing the item information and relationship information includes extracting the item information and relationship information from at least one learning configuration.

19. A computing device comprising:
a processor; and
a memory coupled to the processor and comprising instructions to:
receive at least one learning configuration related to an acceptable arrangement of items within an environment;
extract from the at least one learning configuration representative item information and representative relationship information;
synthesize a configuration of items for the environment based at least in part on the extracted representative item information and relationship information;
determine a cost of the synthesized configuration; and
based on the cost of the synthesized configuration, identify the synthesized configuration as an acceptable configuration.

20. The computing device of claim 19, wherein determining the cost includes calculating at least one cost parameter selected from:
a cost of a position in an X-Y configuration space;
a cost of a position in an X-Y-Z configuration space;
a cost of a position of a first item with respect to an accessible space of another item;
a cost of a position of a second item with respect to a viewing frustum of another item;
a cost of violating a constraint of a spatial relationship; and
a cost of violating a constraint of a pairwise relationship.
